(19) United States
(12) Patent Application Publication
(10) Pub. No.: US 2006/0010468 A1
(43) Pub. Date: Jan. 12, 2006

(54) Broadcast system

(76) Inventor: Robert Graham Loughridge, Wentworth Estate (GB)

Correspondence Address: FLYNN THIEL BOUTELL & TANIS, P.C., 2026 RAMBLING ROAD, KALAMAZOO, MI, 49008-1631, US

(21) Appl. No.: 11/115,066

(22) Filed: Apr. 26, 2005

(30) Foreign Application Priority Data
Apr. 26, 2004 (GB) 0409226.8

(51) Int. Cl. H04N 5/445

(52) U.S. Cl. 725/38

(57) ABSTRACT

A broadcast system is described for the distribution of audio and/or video data. A graphical user interface is provided, preferably via a dedicated website, on a network, for the selection of instances of the audio and/or video data. Upon selection of such data for play back, the data is streamed or otherwise transmitted to a user terminal and a charge is levied to the provider of the data. The instances of data are displayed on the graphical user interface by means of a menu window in which icons corresponding to the instances of data are caused to scroll. When a pointer device is moved over an icon, the icon is enlarged, and the scrolling of the list may be stopped.

The present invention relates to a broadcast system for broadcasting audio and/or video data, in particular to a method and system of broadcasting such data over a public network such as the Internet.

Existing broadband Internet access makes the streaming of video and/or audio data possible to individual computer terminals upon request. The video and audio data, hereinafter called broadcast data, can be received on demand in real time, or can be stored for later viewing. Recent studies showed that many company employees now watch television broadcasts at their computer terminals while at work. Indeed the statistics reveal that more company employees now watch television broadcast on their computer terminals at work, than watch on a standard television set. Such television broadcasts might typically be from news agencies, such as CNN, and give business information or current events. While such information is useful for a company, the broadcast data received merely serves as a useful resource, which the company uses passively.

It is also known that companies typically must advertise in order to increase awareness of their products or services in the market place. Typically, companies may choose to advertise in any number of ways, such as newspapers, trade publications, mail, Internet sites, and television commercials for example. Such advertisements may be expensive and have an indiscernible effect.

We have appreciated that the present situation for companies is not advantageous, as it can lead to inefficient use of resources, and difficulty in assessing the effect of any marketing campaigns.

A general discussion of known computer systems that are relevant to the embodiment of the invention will now be described.

It is commonplace for a computer program to involve, when running, the presentation of a variety of different modules of information. Such modules are typically presented in individual information display boxes.

Considering an individual module of information, this is often relatively large, such as a multi-page document in a word processor program. The box in which it is presented on the computer screen is at most the size of the screen, and is often substantially smaller than the screen. The box in which the information then appears can then be regarded as an opening through which a part of the information is actually visible. Generally, means are provided for enabling the box to be moved over the information module, so that different parts of the information module may be seen as desired. The box is generally rectangular.

The information module may exist as a complete unitary entity, with the box being moveable at will to any part of it. Alternatively, different parts of the information module may be generated in response to the position and movement of the box. Thus, in word processing, regions of the document close to the box, may be generated in image (“real”) form so that they will be displayed immediately if the box is moved to them, but regions remote from the box (eg portions several pages away from the page or pages currently in the box) may be in stored (“virtual”) form, typically as ASCII text plus control information about type face, type size and so on. Another example is where the document includes diagrams or formulae; in some computers, moving to a page which includes a diagram may result in a noticeable pause before the diagram is displayed.

An information module may be static or dynamic, with various possible degrees of dynamism. A read-only document will be essentially static. A word processing program has a slight degree of dynamism, in that the text can be changed by the user. Other programs may for example include animations, where the information module (or parts of it) are changing continuously.

Almost every program will include several information modules and their respective boxes. Broadly speaking, the program will include a corresponding number of program modules, one for each information module and associated box. The program modules will often effectively be running independently and in parallel (this may be achieved by some form of time-sharing and switching at the implementation level). The program will also include supervisory means, which organise and control the individual program modules and the organisation of the corresponding boxes on the screen. The various boxes will often be at least partially hierarchical, with some inside others.

In a similar way, the operating system of the computer will normally handle the placement of the boxes corresponding to different programs running at the same time on the computer (such boxes are generally independent of each other). Commonly the operating system allows the user to control the positions and sizes of these boxes and their hierarchy or ordering, so that if boxes overlap, those lower in the hierarchy are obscured by those higher in the hierarchy, which are fully visible.

In the case of a single computer, all the programs are obviously resident on that computer. If the computer is part of a network and/or is connected to the Internet, then the programs and their modules will normally be largely resident on the computer, though occasionally some downloading onto the computer may be required. To some extent, program modules on the computer may call for information from remote sources. Alternatively, the program (or what may be regarded as its core or controlling master portion) may exist essentially at the remote source, driving and controlling modules resident on the computer, with those modules often, of course, obtaining some information from the master program (or indeed other largely independent remote sources).

Turning now to different aspects of computer programs, the great majority of programs involve interaction between the program and the user, and more particularly permit the user to make a variety of choices. A standard way of providing such choices is by means of menus. In theory, a menu may be essentially abstract, with choices being made eg: by pressing the control key together with a character key. In practice, however, a menu is almost invariably displayed as a list of some sort, with selection being made by means of a pointing device such as a mouse.

For this the operating system includes a mouse program module which generates a pointer on the display. The mouse program is fed from the mouse, so that movements of the mouse are converted to corresponding movements of the pointer on the screen. In addition, various control signals can be generated by the mouse; the main ones are single click (a short depression of the mouse); double click (two single clicks in quick succession); right click (clicking the right hand button), and drag (holding the left-hand button down while moving the mouse).

The mouse program makes the pointer position and the mouse control signals available to other modules in the operating system, and also to application programs (such as the word processing program discussed above). The default pointer generate by the mouse program module is usually an arrowhead. However, the mouse program module can normally receive signals from other programs (modules in both the operating system and application programs) and change the pointer to other forms, eg an “I” cursor, a pointing hand, a grasping hand, ext, in various circumstances.

A menu is in essence a list of items which is displayed on screen so that any desired item can be selected. An item is normally selected by moving the mouse pointer onto it and clicking (either single clicking or double clicking) the mouse. This generally results in the opening of new boxes and often the closing of some existing boxes.

In more detail, there is a menu program module, which includes (or has access to) a list of the menu items. This module displays each item of the menu in a respective box. The item may be textual and/or graphic, possibly animated, and may include a button image, either adjacent to or including the textual and/or graphic information. Such information is typically stored in a list or similar storage structure. In addition, the module defines, for each menu item, a respective zone in the display.

The menu module monitors the mouse program module for a selection signal. If such a selection signal is produced, the menu module obtains the pointer position from the mouse program module and determines whether that position lies within any of the menu zones. If it does, then the menu module carries out the action corresponding to the menu item concerned.

The simplest relationship between the menu boxes and zones is for each zone to be coincident with its associated box. However, the box need not be coincident with the box, for example a zone may be confined to a button image within the box, with the box containing graphical and/or textual information which is not within the zone.

Modifications of this basic organisation are of course possible. For example, in a simple system, there may not be a separate box for each item in the menu; the sequence of items may be concatenated into a single textual sequence so organised that each item appears on a separate line, with the zones being aligned with those lines. Another option is for the menu to be presented initially in simplified form, eg showing only the local country, with the menu expanding to a full list of countries if the pointer is moved onto the menu.

Often the simple event of the pointer entering a menu zone is recognised by the menu program module, without the need for a positive control signal to be produced. The menu module then modifies the contents of the corresponding menu box, eg by highlighting, to emphasise the nature of the item, which can then be selected if desired. Instead of or in addition to modifying the menu item, a supplementary message may be displayed close to or over the item. These actions may be subjected to a slight delay if desired.

The number of items to be offered by a menu is often large, so that displaying the full menu is impractical. If the items can reasonably be classified into a tree form, then a hierarchy or cascade of menus can be implemented. But if the items of a menu are flat, ie all on the same footing, it may be difficult or even impossible to employ a hierarchy of menus in a reasonable manner. In some cases, it may be possible to impose a somewhat artificial hierarchy. Thus, if the items are textual, they can be treated as a form of index, and an initial menu can offer a selection by the initial letter. But that technique if often undesirable or impractical.

A common way of dealing with a large flat menu is to treat the menu as a module of information which is displayed in an associated box which is smaller than the information module, together with the means (controlled by the menu program module) for moving the box over the information module (or equivalently for moving the information module under the box). This requires the provision of some means of moving through the sequence of menu items.

One way of achieving this is to provide a scroll bar adjacent to the list of menu items. The scroll bar is, in this context, a rectangular strip representing the total length of the list of the menu items, with a button on it representing the position in the list and the size of the group of items which are currently displayed in the menu box. The button can be dragged along the scroll bar strip by means of the mouse, and the menu program module moves the menu information item through the menu box correspondingly. The scroll bar is generated and controlled by a scroll bar program module coupled to the menu module and the mouse module; such scroll bar modules are well known, eg in word processing programs;

Another way of achieving movement of the menu information module through the menu box is for the menu program module itself to monitor and respond to the position of the pointer. If the pointer is simply moved into the box and then moved near to or beyond one end of the visible portion of the menu list, the menu program module scrolls the menu list (with the parts of the list at the other end of the box disappearing of course). The selection of a menu item in the box is achieved by moving the pointer between the ends of the menu box to the desired item, and selecting it in the usual way.

These two techniques can of course be combined, and variations on them are of course possible.

### SUMMARY OF THE INVENTION

The invention is defined by the Independent claims which should now be referred to. Advantageous features are set forth in the Independent claims.

### BRIEF DESCRIPTION OF THE DRAWINGS

The invention will now be described in more detail by way of example and with reference to the drawings in which:

FIG. 1 is a block diagram of the entire system;

FIG. 2 is a diagram of a typical screen display;

FIG. 3 is a diagram of the logical elements provided at the host computer;

FIG. 4 is a flow diagram illustrating the operation of the system;

FIG. 5 is an abstract block diagram of the organisation of a user terminal; and

FIG. 5A shows the video box list of FIG. 5 in more detail; and

FIG. 6 is a screen shot showing the preferred interface.

### DETAILED DESCRIPTION OF THE PREFERRED EMBODIMENTS

A preferred broadcasting system will now be described. This comprises a broadband interactive television channel display system. The preferred embodiment allows a host or operating company to provide its client companies with their own fully interactive television channel, managed and operated by the host, in order to serve the client companies' employees, customers, shareholders, and the broadband internet community globally. Preferably, the entire operation is wholly separate from the companies' traditional existing web sites; the television material is hosted on the host's servers and has broadband delivery globally via the Internet. The system also diagnoses what media software the viewing visitor has (eg Windows Media player, Apple Quicktime Player) and automatically adapts to that. This removes the cumbersome and time-consuming need, which is commonplace at the moment, for the visitor to select and download video streaming software.

The host will normally prepare the material, carrying out the filming and encoding and digitising all TV material in order for it to be internet enabled. (This is a different technical requirement to encoding for CD ROM or DVD, for example). The result is typically a set of company movies together with a set of associated video boxes. A video box may be considered to be the icon presented on screen which the user can select to view a portion of video, as well as the video clip itself. Together the company movies and video boxes form the television channel for the company.

The system provides, on a user terminal, such as a PC, or personal digital assistant, a screen with an interactive scrolling bar of video boxes at the bottom of the screen from which the visitor to the system can select TV material to be played in a main box in the middle of the screen or computer monitor. When the user runs the pointer over a video box, the scrolling stops and a description of what is held in that video box appear. By clicking on the selected video box, the associated video plays in the main central box on the screen. The screen is preferably accessed by entering a predetermined address or Universal Resource Locator (URL) into an Internet Browser. The user is then taken to a dedicated Internet site at which the company movies or video clips can be viewed. The site is preferably encoded in HTML, and incorporates Macromedia Flash, as well as original proprietary application code.

The system operates as a hierarchy of two or more levels. In a simple form, there will be two levels, one for the selection of a company from a range of companies, and the other for presenting the selected company's details. The different levels have matching structures, and the number of levels can be increased as necessary with capacity limited only by the number of company movies that can be stored. In a practical implementation it is desirable to provide storage capacity for as many company movies are required, so the levels can be thought of as having infinite capacity. The system therefore allows a client to archive in a friendly way an infinite amount of video data in a television library archive system.

The initial level presents a sequence of video boxes identifying the various companies. If the number of companies is large, then one or more additional levels may be introduced, so that a desired company can be selected for example by industry sector, and then by the company identifier in that sector.

Once a company has been selected, there will typically be several video boxes for that company. Thus Box 1 could be the CEO's welcome message and overview, Box 2, the head of R&D's insight into latest product developments, Box 3, the FD's quarterly presentation to shareholders (with the option of password protected access for this, and any other box that the owner company wishes to protect), Box 4 the manufacturing process, Box 5 happy customer testimonials, etc. The system is scaleable, so video boxes can be added indefinitely.

The format also incorporates a number of interactive buttons to electronic assets provided by the company (annual report, product information, etc.). An interested viewer can thereby email the company, download product information request annual reports etc.

Obviously, the system can be used for other commercial or non-commercial applications, eg tourism, where regions, towns, other tourist attractions, etc, are displayed instead of companies. For convenience, however the system will be described in terms of its use by commercial companies.

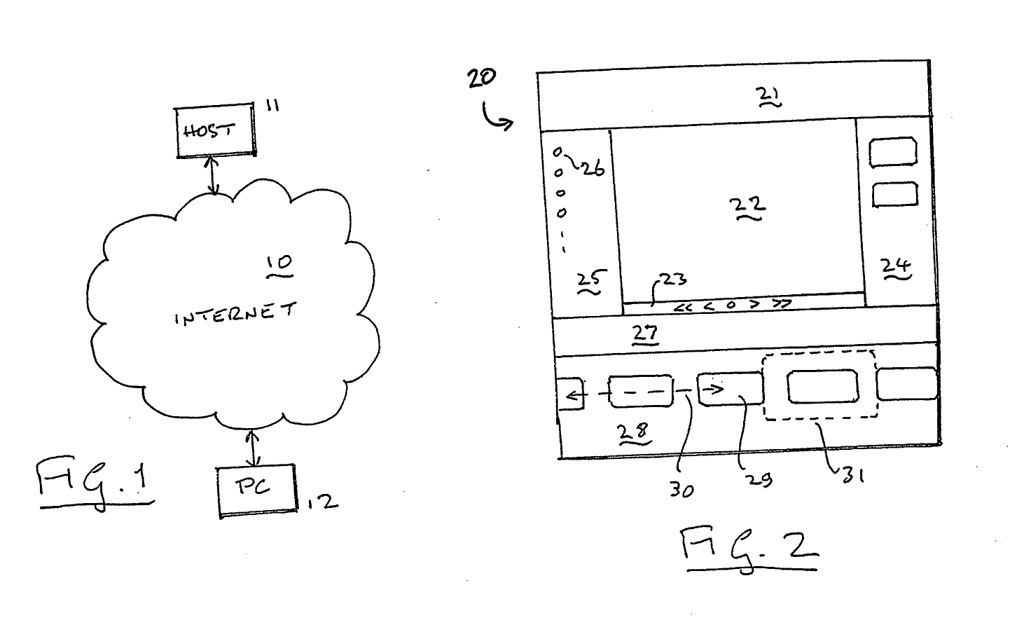

Referring to FIG. 1, the system comprises a host computer 11, coupled to a user terminal 12, which is typically a PC or other computer such as a personal digital assistant for example, through the Internet 10. A single user terminal is shown, but there may be many such terminals simultaneously coupled to the host computer and running effectively independently. The host computer 11 is preferably effectively stand-alone, but it may provide hyperlinks to other systems if desired, such as corporate Intranets. The Internet 10 and the connections to it are preferably broad-band connections capable of supporting video signals.

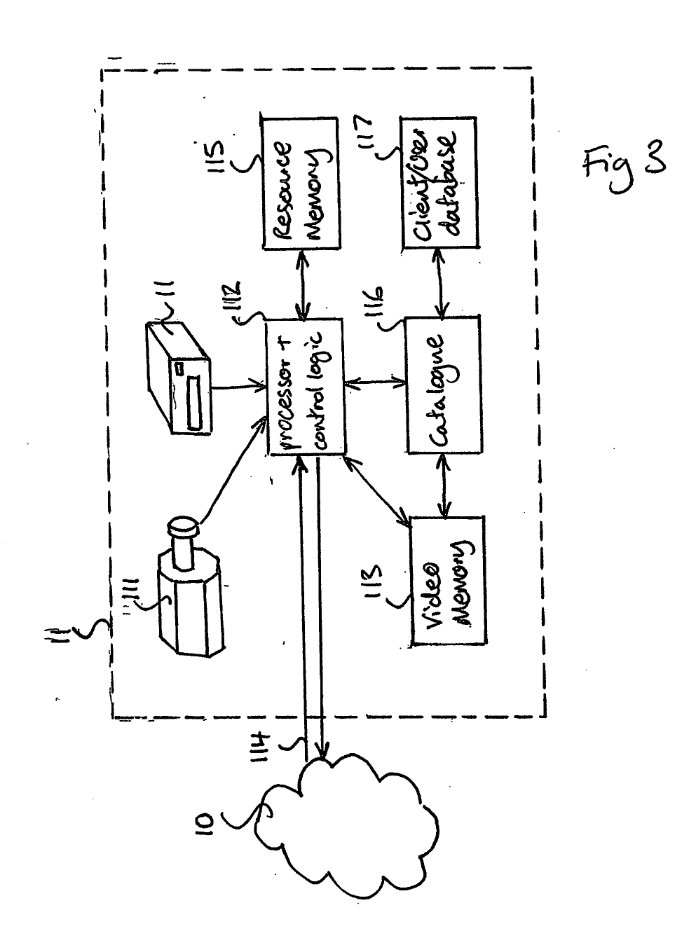

FIG. 2 shows a typical screen display 20 of the system on the user terminal 12. The screen is divided into several different areas or boxes. Box 21 is typically used for host information, logo, etc, and may additionally provide a drop-down menu for accessing video boxes if desired. Box 22 is the main video display area, and has an associated speed control area displaying fast reverse, reverse, pause, play, fast forward button, as well as any other desirable control buttons for controlling the display of the video in the main video display area 22. Box 24 is used for displaying miscellaneous images, such as the client company logo, when a company has been selected. In a main first screen, this area may present selectable company logos for taking a user to the video data stored in respect of that company. Preferably, box 24 also has a prominent video link, which will take the user to a video featured for special attention for that day, week etc. In this way, a showcase facility can be provided.

Box 25 contains a set of buttons which can be used to select various options once a company has been selected. These options may include, for example, viewing the annual report, emailing direct to the company, obtaining product information from the company and so on. At the top level of the hierarchy, this may include a “company of the month”; at the level at which a company has been selected, this may include the company logo, “stop press” material relating to the company, part or all of the movie (video) material of the company, etc. Box 28 is the menu box which will be described in more detail later. A screen shot of the preferred interface is shown in FIG. 6 to which reference should now be made.

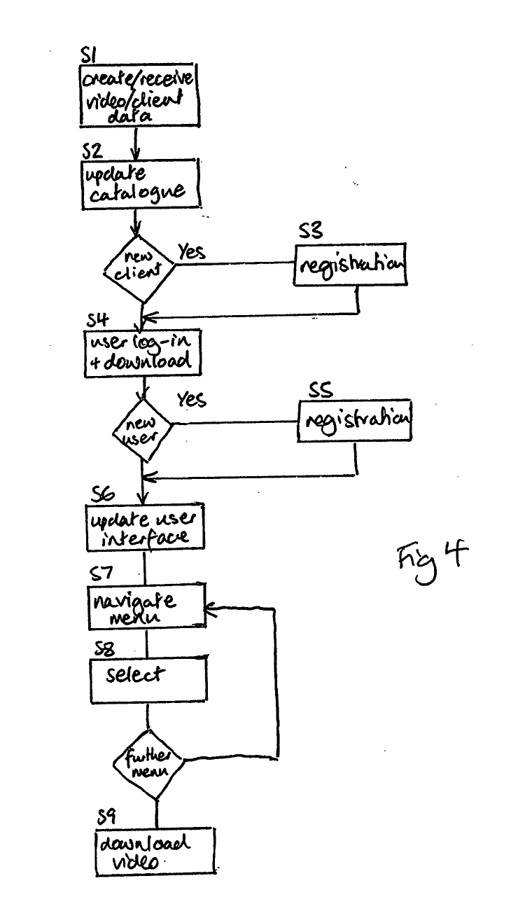

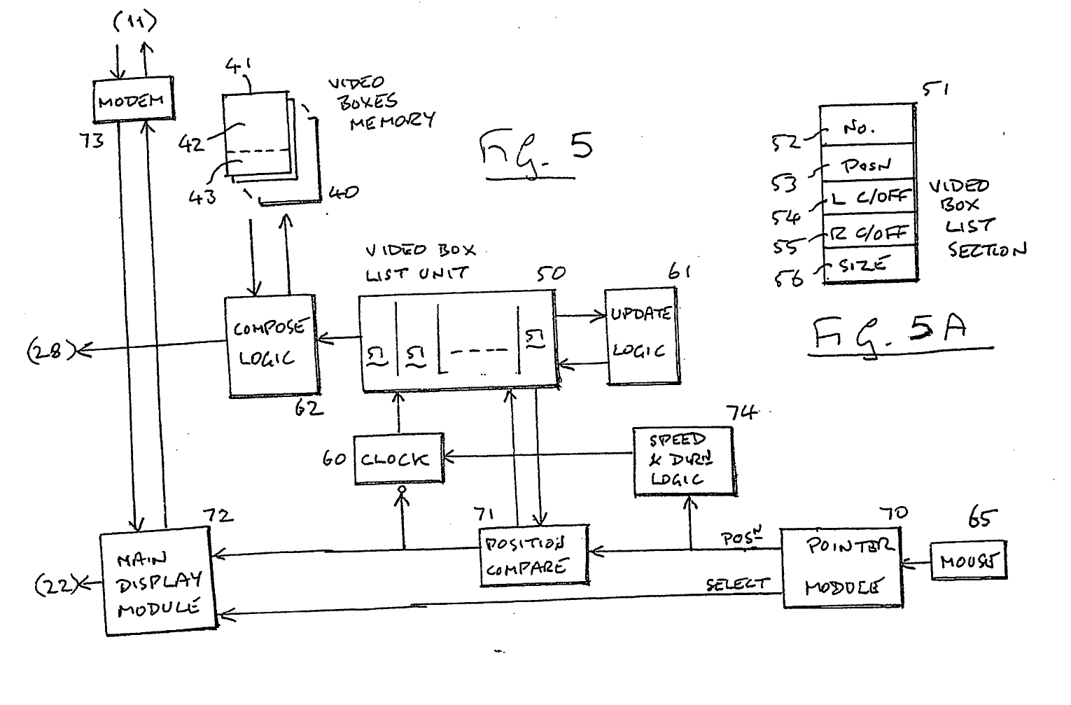

The operation of the preferred system will now be described in more detail with reference to FIGS. 3 and 4. FIG. 3 is a schematic diagram of the logical structures and functions provided at the host computer or server.

For the purposes of this description, the term broadcast data shall be understood to mean any video data, which when displayed produces a moving picture representation with sound of a filmed event or animation. Broadcast data may also include animations or computer generated presentations if so desired.

The host computer or server 11 preferable comprises input devices 111 such as a camera and microphone, disk drive, CD reader, memory stick and so on for creating or receiving new audio/video data. The input devices are logically connected via a processor 112 to video memory 113 in which the audio and video data is stored. Control logic in the processor 112 is arranged to store broadcast data in the video memory, and access the video memory in response to demands for audio/video data received through an Internet connection 114. The internet connection may be via a modem, although this is not shown in the Figure. The processor is also connected to the resource memory 115, which stores the data for generation of the graphical user interface of the host web site at the user's machine 12. It may also store the graphical data for respective clients, such as company logos, or video box data graphics and so on.

A video material catalogue 116 is also logically connected to the processor. The catalogue contains a list of the available video material, namely the video clips or movies that can be viewed, as well as other information such as the client for the video material and hierarchy data. The hierarchy or menu data is provided to indicate how the video material is to be presented via the graphical user interface on the host web site.

Preferably, a selected video clip is presented to the user, by streaming the video data to the user terminal such that it is displayed in the main box 22 of the graphical user interface. The clips may also be downloaded, but this can be undesirable as a copy of the video material then exists at the user terminal and may be copied or otherwise distributed without the owners consent.

At the simplest level, the video material for a particular client may be organised such that it has no hierarchy. That is, once the client is selected from a video box or menu option, all of the video material may be made immediately available via the scrolling menu box 28 at the bottom of the user's screen, such that it can be selected in any order. However, the client may wish to organise the video material into groups, and present these via separate sub menu options. For a company, such menus might be “company statement”, “overview of company projects”, “recruitment opportunities” and so on. Each of these submenus, once selected, might involve the playing of a video clip, or might simply take the user to the next level of the scrolling menu. The menu options shall be understood to correspond to the video boxes mentioned above, although is not necessary that selection of a video box leads immediately to the display of video material. The hierarchy or menu data stored in the catalogue can therefore be used to build a directory of different video material. An example of such structure is illustrated below in pseudocode.
Menu Option #1: Company A
   Menu Option #1:1 “Company Statement”, <graphic a>
      Video Clip #1:1a
      Video Clip #1:1b
   Menu Option #1:2 “Overview of company projects” <video clip #1:2>
      Video Clip #1:2a
      Video Clip #1:2b
      Video Clip #1:2c
   Menu Option #1:3 “Recruitment opportunities” <graphic b>
      Video Clip #1:3a
      Video Clip #1:3b

Each of the top level entries in the catalogue defines a menu option or video box. These are displayed in menu box 28 when a user logs onto the site as a top level menu. Subordinate entries define successive menu options in sub menus. Thus, each entry that does not represent the last level in a menu, could be thought of as a sub-menu selector.

Each entry not only gives an appropriate textual title for the menu option or video box, but also indicates a link to the location in the video memory where any associated video material is stored, or alternatively for menu options a graphic to display at the point of the menu. The default graphic is merely a box containing the title of the menu option. However, other options may include a video still taken from the video clip accessed by the box or icon, or even a video segment from the video clip.

As indicated above, selection of a menu option might result in the playing of a video clip before a lower level menu is accessed. This is achieved by associating a video clip with the menu option. When Menu Option #1:2 is selected for example, video clip 1:2 is first played. At the end of the video, a menu for video material 1:2a, b and c, is then presented. The hierarchy or menu data is therefore an advantageous way of structuring the storage and presentation of the video material to the user.

The top level of the menu will typically contains items relating to the companies or owners that have provided the video clips. Alternatively, they menu items may specify portals or menu items that contain video clips grouped by subject matter, target audience.

A client/user database 117 is also provided for storing data about the clients and end users of the system. For clients, the data preferably includes name, contact information, address and billing information, a link to the catalogue entry listing the video material stored for the clients, and an entry indicating how many times each element of video material has been viewed. The user information preferably includes, name, contact information such as an email address, and the IP or URL address of the user terminal. The user information also preferably includes which elements of video material have been selected for viewing, and which have been completely viewed.

Next, with reference to FIG. 4, a description of the operation of the system will be given including the interaction of the client and user, as well as the underlying technical processes.

In step S1, a potential client approaches the host to arrange for video material to be placed on the host website. As noted above, the host preferably provides professional broadcast material production services to produce the video material for the client according to the client's specifications. This may involve the supply of both technical facilities and expertise, such as making available presenters of different nationalities, producers, camera operators and other production staff for on-location or studio based filming, as well as facilities to produce animation. Alternatively, clients may provide their own pre-recorded video material if they wish, subject to tem providing it in a suitable format.

Video material is therefore received via the input devices 111 and stored in the Video Memory 113 of the host computer 11. At the same time, the client provides information about how access to the video material is to be structured. This information will be used to generate the menu structure and menu options or video boxes for display in the graphical user interface on the user terminal. This information may be encoded in the manner described above. Additionally, any graphical information for display on the graphical user interface in connection with the video material is provided by the client, and stored in the resource memory 115. The video material data, menu data, and any graphical data will be used to configure the appearance of the graphical user interface to provide the identity of the company channel.

In step S2, a computer operator at the host updates the catalogue to include the menu structure data and references to the new video material. This process may be automated if desired, providing the input video data, graphical data, and menu data fits a prescribed predetermined format. The catalogue may also store an indication of the cost for downloading or viewing video material for each instance of video material supplied.

If the client is a new client, then client details are also entered at this stage in step S3, and stored in the client database. As indicated above the client details are preferably name, address, email address, and billing address.

In step S4, we now assume that a user having a user terminal sends a request to access the host company web site. The Resource memory contains code, such as HTML, defining the web site through which the user can view the video material. This code is retrieved when an access request for the web site is received from a user and transmitted to the user terminal for display on their user terminal.

At this point, the processor checks the client/user database 117 to see if the user is a new user. If they are, they may be invited to enter identification details in registration step S5 before they can proceed. These details might include name, email address, company and so on. The system also detects the IP or URL address from which the user is accessing the site. This data is stored in the client/user database 117 for further reference. The system may also send a cookie to the user terminal 12 so that a record of the user's site access can be built up for the user, and for data collection purposes.

If it is detected that the user has already registered, or once the registration process has completed, then in step S6, the control logic in the processor retrieves the information stored in the catalogue to update the menu options and graphics presented via the user interface of the web site to the user.

In step S7, the user may then navigate through the various menu options and select video material for viewing. As noted above, the video material is presented via a channel corresponding to a top level menu option and its sub directories. Each channel may be selected using a menu option or video box displayed in menu box 28, or from a button provided in box 24. The use of Box 24 to access channels may allow attention to be drawn to particular channels as part of an additional advertising strategy. Consequently, the charge for viewing video material from channels selected in this way, may be made higher to reflect its prominence on the web site.

It is possible that the user be restricted in the menu options that are available to them. This may be desirable so that a company employee, when accessing the site has access only to channels provided by the company, or to channels the company endorses. Restriction of the menu options in this way, can be achieved by password protection of channels or menu options. To do this, the required password information is stored as a parameter in the menu data. The user must then enter the password on selection of a menu option, video box or button for access. Alternatively, users may be registered so that they are not presented with all of the channels available from the catalogue, but only with an approved subset. This can be achieved by recording in the user data stored in the client/user database 117, which channels are accessible, and requiring the control logic of the processor to filter out any unauthorised channels when the site data is being downloaded. As the IP or URL address of the user terminal is stored in the client/user database, this allows all user terminals located within a client company to be limited to viewing the client's material via the website. Thus, although the client is using the host's centralised internet broadcasting facility, it will appear to the user on accessing the host website as a dedicated site for the client company.

In step S8, the user selects a menu option and the control logic checks the menu data to determine whether the option corresponds to video material, or to another level of menu. The control logic transmits the necessary data to the user terminal to update the display and implements any password protection options that have been specified.

If a video clip is selected then the control logic streams or transmits the video data to the user terminal in step S9, and updates the client/user database to indicate for a particular client that one of their video clips has been streamed to the user terminal and viewed. An entry is also made in the user part of the database, indicating that the user has viewed a particular clip.

Preferably, any video clip that is already playing in the main display window 22, is left playing when a menu item that does not directly result in the playback of a video is selected. This allows the menu system to be navigated independently of the viewing facility.

Recording the video clips that have been viewed for each client and user provides various management and organisational advantages. Firstly, it allows the client to be billed on the basis of only those video clips that have been streamed or downloaded. This pay structure is preferred as it encourages clients to register with the site in the knowledge that, once the video material has been prepared and uploaded, they will only be charged again according to the actual demand for the material. Additionally, it encourages users to view the material, as essentially it is free-to-view.

Maintaining user viewing statistics also allows a company to monitor whether their video material is being viewed or not. If the video material relates to training or safety videos, this data is useful as it allows the company to confirm that employees have watched the required training or safety broadcasts.

Preferably, the client and the user database are updated in this way, only when the video clip has been viewed in its entirety. This ensures that if the video clip is terminated half way through, or streaming of the clip cannot be fully completed the client is not charged, and the user is not credited with viewing the material.

Having described the general operation of the preferred system, the advantageous selection method employed to navigate through the menu options will now be described.

Considering box 28 in more detail, a sequence of video boxes 29 is displayed in it. Each video box or video clip is short animation of information or recording relating usually to a different company (although a single company may of course have more than one video box). Additionally, it may also be other data, such as word processing documents, spreadsheets, still graphics and so on. Although these are not ‘video’ data, this allows the system to present both video data and any related information in the same way to the user. The Icons representing these video boxes 29 normally move steadily across the box 28 as indicated by the arrow 30. However, if the pointer (not shown) enters an icon or video box (or, equivalently, if a video box moves underneath the pointer), the movement of the video boxes is interrupted. The video box on which the pointer rests is enlarged, as indicated at 31, and information relating to that video box (e.g. the company name, personal details, and indeed any other details) is displayed in box 27; audio information can also be played if desired. If the user then clicks on the video box, the associated video recording is presented and played in the main video display area 22.

The icon used to represent the video box may contain text or graphical information. Preferably, the video box may contain a still image or video segment taken from the video data it represents.

The video box information must of course be passed from the host system 11 to the terminal 12. This material may be either streamed or downloaded, depending on various factors such as how much information is used to generate the contents of the video boxes. Downloading has the advantage that once the material has been downloaded, the operation of the scrolling menu box 28 is essentially self-contained within the terminal 12, but the disadvantage is that there may be a delay in initiating the video box display and a large amount of memory may be required in to the terminal 12. The video displayed in the main video display area 22 will normally be supplied essentially direct by streaming from the host system 11.

As noted above, the system can be hierarchical, so that the initial selection of a company can be followed by the presentation of a range of options for that company. That presentation can conveniently take the form of scrolling sequences of video boxes representing various aspects of the company's activities. Any desired aspect can then be selected in exactly the same way as the company was selected.

Means are preferably provided enabling the user to control the speed and direction of the scrolling menu. Such means may comprise a speed control area like area 23 or a slider bar. It is preferred to use a “virtual” or invisible slider bar, with the speed and direction being controlled simply by moving the pointer laterally within the area 28. If the pointer is in the left or right half of the area of the area 28, the menu will move leftwards or rightwards respectively, and the speed of movement will increase if the pointer is moved to near either end of the area 28. The movement preferably continues if the pointer leaves the area 28.

Several actions can occur in the course of selecting a video. These include halting the video box movement, enlarging and/or highlighting the selected video box, showing information associated with the video box, and starting the video associated with the video box. These can be divided into more than two sets if desired. Thus the video box movement may halt and the relevant video box enlarge merely on the pointer entering a video box, information associated with that video box may be displayed in single clicking on that video box, and the video associated with that video box may be played in area 28 only on double clicking on that video box.

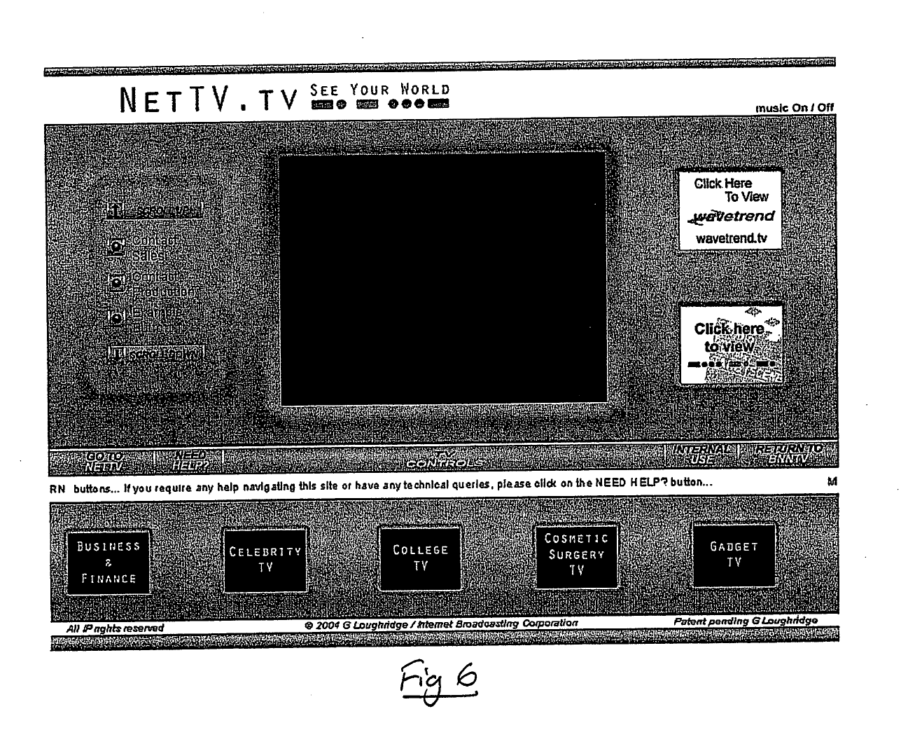

Referring now to FIG. 5, this shows an abstract logic block diagram of the organization of the terminal 12 implementing the system. Only the parts relevant to present purposes are shown.

The system includes a memory 40 which stores the contents of the video boxes 29. Each video box has its contents stored in a respective memory unit 41, which is divided into a main video portion 42 and an auxiliary portion 43 which stores information relating to that video portion. (This includes the information which is displayed in the region 27).

The video box display is controlled by a video box list unit 50, which is divided into sections 51, the number of sections being slightly greater than the number of video boxes which are visible in the area 28. As shown in FIG. 5A, each section 51 has 5 portions; a portion 52 for the number of a video box, a portion 53 for the position of the centre of that video box, a portion 54 for a possible left cut-off, a portion 55 for a possible right cut-off, and a portion 56 for the size of the video box.

The position portion 53 indicates the X co-ordinate of the centre of the video box, i.e. the position in which it is to be displayed in the area 28. (We ignore the Y co-ordinate, as it is the same for all video boxes). This co-ordinate is initialised at 0, and is incremented on each tick of a clock unit 60. The left cut-off portion 54 is calculated from the size of the video box (which is standard), its centre X co-ordinate, and the position of the left-hand side of the area 28. This cut-off is normally 0, but is calculated so as to increase as the video box passes out of the area 28; this prevents the display of the video box from extending beyond the left-hand side of the area 28. The right cut-off portion 55 is calculated like the left cut-off, but for the right-hand side of the area 28; it starts at the total width of the video box, and reduces to 0 as the video box moves wholly into the area 28. The size portion 56 contains the size of the video box, and is used for calculating the left and right cut-offs. The size is normally a standard value, but increase to a larger value when the video box is selected.

The video box memory 40 and the video box list unit 50 are coupled to a compose logic unit 62. This unit cycles repeatedly through the list unit 50 to compose the set of video boxes to be displayed. For each video box listed in unit 50, it obtains the video box content from the video box memory 40 and the video box size, position, and cut-offs from the video box list unit 50, and from this information, it generates the display of video boxes for the area 28.

The video box list unit 50 is also coupled to an update logic unit 61. This unit detects when a video box has passed out of the area 28 and replaces it with the next video box in the remaining sequence in the unit 50. (The sequence of video boxes in unit 40 is regarded as cyclic). The section 51 so updated determines the initial values of the centre X co-ordinate and right cut-off.

The operating system includes a pointer program module 70, which is controlled by a mouse 65. This module generates a mouse position signal and also any select signals produced by the mouse buttons. The mouse position is fed to a position compare unit 71, which compares it with the positions of the video boxes listed in the video box list unit 50.

If the mouse position is found to be within a video box, the position compare unit 71 sends a signal to the clock unit 60 to inhibit it from running. This freezes the video box sequence in the area 28, suspending their usual movement across the area 28. A signal is also sent to the video box list unit 50, to increase the value in the size portion 56 of the section 51 for the relevant video box. This is used to increase the size of that video box (the left or right cut-offs remaining the same).

The system also includes a main display module 72, which generates the main display in area 22. The signal from the position comparator 71 is also sent to this module to cause it (on receipt of a selection signal from the pointer module 70) to terminate whatever display it is currently producing and to display the video sequence corresponding to the selected video box. The number of the selected video box is passed to unit 72, which sends it to the host system 11 via a modem unit 73. The host system 11 returns the full video, as a streamed signal, through the modem 73 to unit 72, which then displays the video in area 22.

FIG. 5 shows the monitor as including a video box memory 40. It will be realized, however, that the information stored therein could equally well be obtained direct from the host system 11 by video streaming via the modem 73 as and when required.

The pointer module 70 also feeds the pointer position to a speed control module 74. This module determines whether the pointer is in the area 28, and if so, what its position is along the X direction. Depending on the sign and magnitude of the X co-ordinate of the pointer relative to the centre of the area 28, this unit sends a signal to the clock unit 60 to control its speed and direction of counting. The speed and direction of the movement of the video boxes is therefore controllable by the user.

If the pointer is moved out of the area 28, the signal from the speed control unit 74 is held at its current value, so that the scrolling continues at its existing rate and direction.

It will of course be realised that this abstract logical organization is described in very simplified terms, and can be implemented in a wide variety of ways. For example, although a PC has been described as the user terminal, it will be appreciated that any Internet enabled computer, such as Personal Digital Assistants, mobile phones, may also be used to the extent that their display and internet streaming capabilities allow.

Additionally, it will be appreciated that live video material could also be made available by the techniques disclosed above. In that case, selection of a video box would result in live footage being streamed to the user terminal. The availability of the video box for selection would then depend on whether a live broadcast was in progress or not.

To summarize, the preferred embodiment comprises a method and system for distributing broadcast data, exemplified as a broadband interactive television channel display system. A menu program module is arranged to automatically move a list of menu items through the menu box, with such movement being interrupted if the pointer is moved into the menu box, or a predetermined region thereof).

The menu is preferably treated as cyclic, with effectively continuous rotation through the menu box.

If desired means may be provided for controlling the speed of the menu movement. Such means may for example comprise a slider box adjacent to or within the menu region or box; the slider box having a button which can be moved along the slider bar to naturally allow the direction of movement, as well as the speed, to be determined. Instead of a visible slider box, a virtual slider box may be used, where simply moving the pointer towards the end of the menu box will result in the speed and direction of menu movement changing accordingly.

Alternatively, there may be a set of speed buttons defining preset speeds, or a pair of buttons one for increasing the speed and the other for decreasing it stepwise.

Menu lists tend to be arranged vertically, particularly if the list consists of a large number of text items (which are normally printed horizontally). However, the preferred embodiment preferably uses a horizontal list, particularly if the items in the list are primarily graphic. Indeed, the present menu box may be angled curved or in disjoint portions if desired. The menu box may be arranged vertically however if desired.

Preferably, moving the pointer onto a menu item interrupts the menu movement and/or causes the item to be modified and/or supplementary information associated with the item to be displayed.

Obviously, more than one such menu program module and menu box may be generated on a common display.

Thus, a broadcast system has been described which provides a virtual television channel to a user. The video material is available on demand but not presented to the user, without their choosing as on standard websites. Additionally, material that is related to the video can also be requested and displayed.

Although the invention has been described with reference to a preferred embodiment, this purely illustrative, and modifications will be apparent to the skilled man within the scope of the invention as defined by the following claims.

1. A broadcast system for transmitting to a user broadcast data comprising at least audio and/or video data; the system comprising:
a computer readable medium on which is stored computer code which when executed on a user terminal generates a graphical user interface from which an instance of broadcast data can be selected for play back; the graphical user interface also having a display region in which the broadcast data is played back;
a memory comprising one or more instances of broadcast data for selection;
hierarchy data defining how the instances of broadcast data are to be displayed on the graphical user interface for selection, wherein the hierarchy data defines at least a first level and a second level containing menu items for accessing broadcast data, the graphical user interface being arranged to initially display the menu items from the first level and wherein the first level comprises a sub-menu selector menu item that when selected takes the user to the second level.

2. The broadcast system of claim 1, wherein the hierarchy data is arranged such that the first level contains menu items corresponding to the owners of the broadcast data.

3. The broadcast system of claim 2, wherein the sub-menu selector is arranged such that when selected, broadcast data is played back before the user is taken to the second level.

4. The broadcast system of claim 2, wherein the sub-menu selector is arranged such that when selected, a user is prompted to enter a predetermined identifier before and access to the second level is permitted or not permitted based on the identifier input.

5. The broadcast system of claim 1, comprising a memory for storing non-broadcast data, and wherein the hierarchy data contains menu items for selection of the non-broadcast data.

6. The broadcast system of claim 5 wherein the non-broadcast data is text data.

7. The broadcast system of claim 1, wherein the graphical user interface comprises radio buttons corresponding to one or more menu items.

8. The broadcast system of claim 1, wherein the graphical user interface has a menu region in which icons corresponding to the menu items are displayed, the graphical user interface being arranged to scroll the menu items in the menu region.

9. The broadcast system of claim 8, wherein the graphical user interface is arranged to scroll the menu items only when there are too many to simultaneously display on the screen.

10. The broadcast system of claim 1, wherein the hierarchy data defines the location in memory where broadcast data corresponding to a menu item is stored.

11. A broadcast system for transmitting to a user broadcast data comprising at least audio and/or video data; the system comprising:
a computer readable medium on which is stored computer code which when executed on a user terminal generates a graphical user interface from which an instance of broadcast data can be selected for play back;
a memory comprising one or more instances of broadcast data for selection;
a memory for storing data identifying the owner of the broadcast data;
a controller arranged to charge the owner of the broadcast data when an instance of broadcast data is selected for play back.

12. A broadcast system according to claim 11, wherein the computer readable medium is a server connected to a network.

13. A broadcast system according to claim 12, wherein the controller is arranged to stream broadcast data that has been selected to the user terminal over the network.

14. A broadcast system according to claim 11, comprising a memory for storing user data identifying users of the system, wherein the user data indicates which instances of broadcast data have been selected for playback.

15. A broadcast system according to claim 14, wherein the user data indicates when an instance of broadcast data has been viewed in its entirety.

16. A broadcast system according to claim 11, wherein the system comprises means for capturing broadcast data.

17. A broadcast system according to claim 16, wherein the means for capturing broadcast data comprises one or more of a camera, a microphone, cassette reader, disk drive, storage device reader, and network connection.

18. A broadcast system according to claim 11, wherein the network is the Internet.

19. A selection system for a computer, comprising a processor arranged to:
generate a graphical user interface from which an instance of data can be selected, the graphical user interface having a menu item display region;
generate an icon corresponding to each instance of data that can be selected;
display one or more icons in the menu item display region such that the icons are caused to scroll in the menu item display region;
monitor a pointer device for input from a user, such that an instance of data can be selected by moving the pointer device onto an icon and activating a selection function of the pointer device, and wherein
the processor is arranged such that when it is detected that the pointer device is moved onto the icon for an instance of data the representation of the icon is enlarged before selection occurs.

20. The selection system of claim 19, wherein when it is detected that the pointer device has been moved onto an icon the scrolling of the icons is stopped.

21. The selection system of claim 20, wherein the position of the pointer device within the menu item display region controls the speed at which the menu items are caused to scroll.

22. The selection system of claim 20, wherein the position of the pointer device within the menu item display region controls the direction in which the menu items are caused to scroll.

23. The selection system of claim 19, wherein the icon contains text and/or graphical data identifying the instance of data.

24. The selection system of claim 19, wherein the instances of data include instances of video data that can be selected for viewing.

25. The selection system of claim 24, wherein the icon comprises a still image taken from the instance of video data.

26. The selection system of claim 24, wherein the icon comprises a video segment taken from the instance of video data.

27. A method of distributing audio and/or video data comprising:
providing a graphical user interface accessible via a network; the graphical user interface having links to one or more instances of audio and/or video data for playback;
receiving a user input indicating a selection of audio and/or video data for playback;
transmitting the audio and/or video data to the user, in response to the selection;
charging the supplier of the audio and video data when the audio and video data is transmitted to a user.

28. A method of distributing broadcast information, comprising:
receiving an instance of broadcast information from a client, or generating a broadcast instance for the client;
providing a web site from which the broadcast information can be accessed;
recording the number of times an instance of broadcast data is accessed;
charging the client in dependence on the number of times the instance of data has been accessed.
